(19) United States
(12) Patent Application Publication
(10) Pub. No.: US 2004/0101359 A1
(43) Pub. Date: May 27, 2004

(54) Hybrid plug-n-play module attachment

(76) Inventors: Richard L. Gottorff, Rochester, NY (US); Eric A. Falter, Rochester, NY (US); Jeffrey J. Roodbeen, Waterford, MI (US)

Correspondence Address: YOUNG & BASILE, P.C., Suite 624, 3001 West Big Beaver Road, Troy, MI, 48084-3107, US

(21) Appl. No.: 10/305,899

(22) Filed: Nov. 27, 2002

(51) Int. Cl. B60S 1/02

(52) U.S. Cl. 403/408.1

(57) ABSTRACT

A windshield wiper system mounting apparatus includes at least one plug-n-play grommet, at least one fastener grommet, and at least one bayonet grommet. The grommets connect the mounting apparatus to the support wall associated with the vehicle body in a simplified manner.

### FIELD OF THE INVENTION

The present invention relates to an attachment device for a windshield wiper system for motor vehicles.

### BACKGROUND OF THE INVENTION

Current plug-n-play module attachment devices are not sufficiently rigid for a high load system. As a result, wipe pattern growth can be seen over the life of the product. Additionally, it would be desirable to reduce the potential for disassembly of the plug-n-play attachment from the vehicle mounting positions.

An attachment device is known for a windshield wiper arrangement for motor vehicles with a non-screw type mounting. The attachment device has a support element carrying a windshield wiper drive device with two lateral plug-in pegs located parallel to one another and protruding in the same direction diagonally with respect to wiper shafts mounted on the device. These plug-in pegs, together with a third plug-in peg, are located respectively on corner points of a triangle, where the third plug-in peg extends in a vertical plane perpendicular to the two other plug-in pegs.

### SUMMARY OF THE INVENTION

Currently, wiper modules are attached with three fasteners, or two fasteners and a bayonet grommet. The present invention includes an attachment method referred to as a plug-n-play module including barbed grommets and tenons in place of at least some fasteners for attachment of the wiper module. The present invention includes an attachment module with one plug-n-play grommet, one fastener grommet, and one bayonet grommet. The present invention allows for the simplification of assembly using only one fastener, while minimizing wipe pattern growth over the life of the windshield wiper system. The present invention further reduces the potential for unintentional disassembly of the windshield wiper system mounting device from the motor vehicle by preventing the plug-n-play grommet from dislodging from the vehicle mounting point.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a perspective view of a windshield wiper system mounting apparatus according to the present invention;

FIG. 2 is a detailed cross-sectional view of the fastener grommet attachment according to the present invention;

FIG. 3 is a detailed cross-sectional view of the plug-n-play grommet assembly according to the present invention; and

FIG. 4 is a detailed cross-sectional view of the bayonet grommet attachment according to the present invention.

### DESCRIPTION OF THE PREFERRED EMBODIMENT

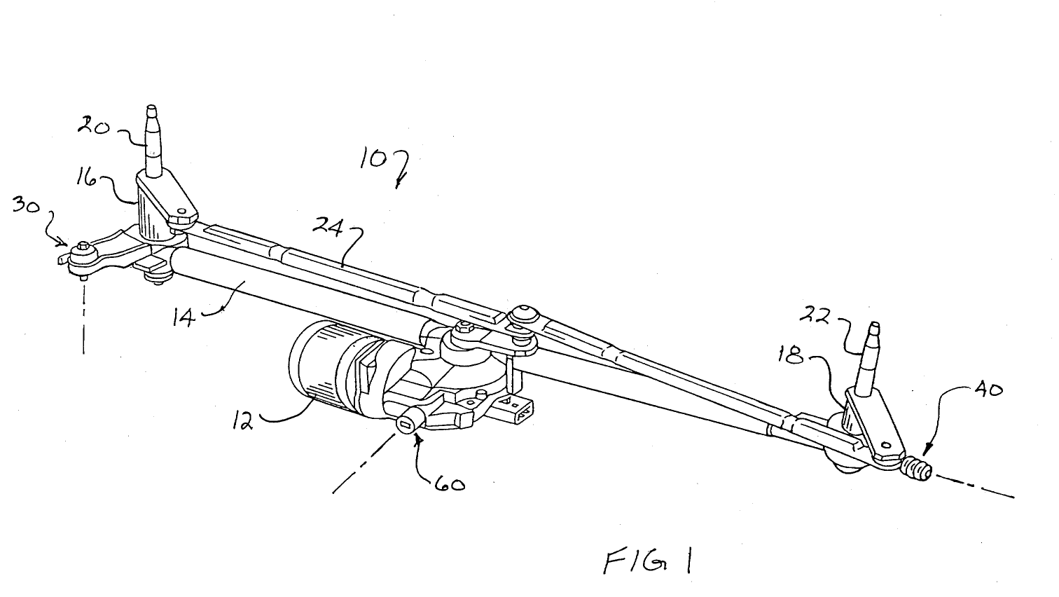

A windshield wiper system mounting apparatus 10 for motor vehicles is illustrated in perspective view in FIG. 1. The mounting apparatus 10 can include a windshield wiper drive 12 premounted thereon. A support member 14 of the mounting apparatus 10 carries bearing elements 16, 18 at opposite ends for rotatably supporting corresponding wiper shafts 20, 22 in an axially secured manner. Coupling links 24 extend between the windshield wiper drive unit 12 and a corresponding crank arm connected to each of the wiper shafts 20, 22. The coupling links 24 transfer rotational motion of the crank arm of the wiper drive unit 12 into synchronized oscillatory movement of the wiper shafts 20, 22. The mounting apparatus 10 according to the present invention is connectible to a support wall 26 associated with the vehicle body. The mounting apparatus 10 according to the present invention permits the rotational axes of the wiper shafts 20, 22 to be properly positioned with respect to a windshield to be wiped associated with the vehicle body.

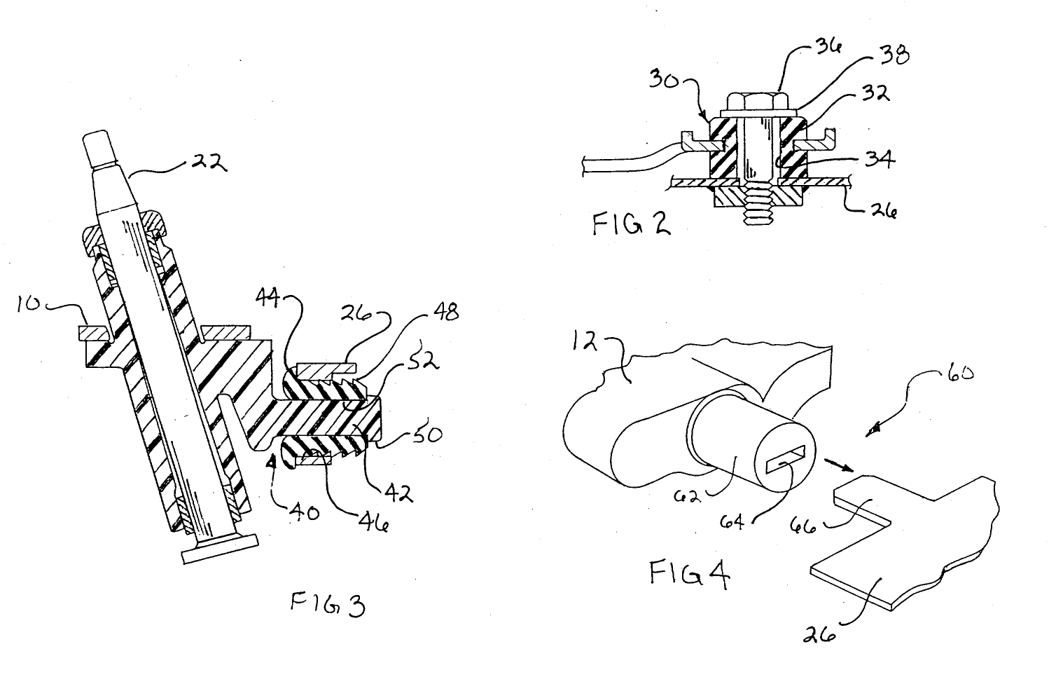

Referring now to FIG. 2, the mounting apparatus 10 according to the present invention can include a fastener grommet 30. The fastener grommet 30 can include a vibration dampening portion 32 and an aperture 34 defining a passage for a threaded fastener 36. The threaded portion of the fastener 36 is engagable with internally threaded attachment bores formed in the support wall 26 associated with the vehicle body. A rigid shell 38, such as a metallic washer and/or partial cylindrical sleeve can be associated with the aperture. A typical example of a fastener grommet 30, by way of example and not limitation, can be seen in U.S. Pat. No. 5,609,329 which is incorporated by reference herein in its entirety. The fastener grommet 30 can be located adjacent one end of the elongate support member 14.

Referring now to FIG. 3, the mounting apparatus 10 according to the present invention includes a plug-n-play grommet 40. The plug-n-play grommet 40 is preferably located adjacent an end of the support member 14 opposite from the fastener grommet 30. The longitudinally extending insertion axis of the plug-n-play grommet 40 preferably extends in a non-parallel direction with respect to the longitudinal insertion or rotational axis of the threaded portion of the fastener 36. In the illustrated embodiment, the longitudinal insertion axis of the plug-n-play grommet 40 extends in a direction generally perpendicular with respect to a longitudinally extending rotational axis of the fastener 36. The fastener 36 and the plug-n-play grommet 40 are generally located at or adjacent opposite ends of the support member 14. The plug-n-play grommet 40 includes a tenon/pivot projection 42. An isolation, vibration dampening grommet 44 can be premounted on the projection 42, or mounted in an opening 46 formed in the support wall 26 associated with the vehicle body. The isolation grommet 44 can include outwardly extending barbs 48 to maintain the grommet 44 within the opening 46 formed in the support wall 26 after insertion. If the isolation grommet 44 is prepositioned on the projection 42, the projection 42 can include an enlarged head portion 50 for maintaining the grommet 44 in the installed position with respect to the projection 42. The grommet 44 includes an aperture 52 for receiving the projection 42 therein. Alternatively, the grommet 44 can be crimp staked to the projection 42, or any other suitable adhesive or mechanical anchoring can be used to connect the grommet 44 with respect to the projection 42. When installed within the opening 46 formed in the support wall 26 associated with the vehicle body, the grommet 44 is in a compressed state in areas between the projection 42 and the surface defining the opening 46 in the support wall 26.

Referring now to FIG. 4, the mounting apparatus 10 according to the present invention includes a bayonet grommet 60. The bayonet grommet 60 forms a connection with the support wall 26 associated with the vehicle body using complementary male and female portions. The complementary male and female portions can be mounted on either of the mounting apparatus 10 and support wall 26. The bayonet grommet 60 preferably includes a vibration dampening portion 62. The vibration dampening portion 62 can be preassembled to the mounting apparatus 10 or the support wall 26 associated with the vehicle body. By way of example and not limitation, the illustrated embodiment of FIG. 4 shows a bayonet grommet 60 having an aperture 64 formed through a vibration dampening material portion 62 for receiving a projection 66 associated with the support wall 26 of the vehicle body. The bayonet grommet 60 includes a longitudinally extending insertion axis separate and independent from the longitudinally extending insertion axis of the plug-n-play grommet and the longitudinally extending insertion axis of the fastener grommet. The insertion axis of the bayonet grommet 60 preferably extends in a non parallel relationship with respect to the longitudinal insertion axis of the plug-n-play grommet and the longitudinal insertion axis of the fastener 36. The longitudinal insertion axis of the bayonet grommet 60 preferably extends in a direction generally perpendicular with respect to the longitudinal insertion axis of the plug-n-play grommet 40 and/or the longitudinal rotational axis of the threaded portion of the fastener 36. In the illustrated embodiment, the longitudinal insertion axis of the bayonet grommet 60, the longitudinal insertion axis of the plug-n-play grommet 40, and the longitudinal insertion axis of the fastener 36 are generally perpendicular with respect to each other.

In operation, the mounting apparatus 10 according to the present invention allows easy installation of the windshield wiper system with respect to the support wall 26 associated with the vehicle body. The plug-n-play grommet 40 is insertable within the opening 46 formed in the support wall 26 associated with the vehicle body. The plug-n-play grommet 40 allows sufficient pivotal and longitudinal movement to align and engage the complementary portions of the bayonet grommet 60. The threaded fastener 36 can then be aligned with the aperture 34 and the threaded bore formed in the support wall 26 associated with the vehicle body for attachment of the mounting apparatus 10 to the vehicle body. After sufficient tightening of the fastener 36, the mounting apparatus 10 supports the windshield wiper drive 12 and associated wiper shafts 20, 22 in the proper orientation with respect to the windshield to be wiped. Vibration dampening portions at the three mounting locations isolate the mounting apparatus 10 according to the present invention from the vehicle body. The present invention allows for the simplification of assembly using only one fastener, threaded or with push on lock washer, while minimizing wipe pattern growth of the windshield wiper system over the life of the assembly. Additionally, the present invention traps the plug-n-play grommet 40 between the support member 44 and the opening 46 formed in the support wall 26 of the vehicle body.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An apparatus for mounting a windshield wiper system to a motor vehicle comprising:
an elongate support member connectible to a windshield wiper drive;
at least one plug-n-play grommet connectible to the support member;
at least one fastener -grommet connectible to the support member; and
at least one bayonet grommet connectible to the support member, wherein each grommet includes an insertion axis extending in a non-parallel relationship to the insertion axes of the other grommets.

2. The apparatus of claim 1 further comprising:
each grommet including a vibration dampening portion to be attached with respect to the motor vehicle.

3. The apparatus of claim 1 further comprising:
the insertion axis of the bayonet grommet being located generally perpendicular with respect to the insertion axis of the plug-n-play grommet.

4. The apparatus of claim 1 further comprising:
the insertion axis of the bayonet grommet being located generally perpendicular with respect to the insertion axis of the fastener grommet.

5. The apparatus of claim 1 further comprising:
the insertion axis of the plug-n-play grommet being located generally perpendicular with respect to the insertion axis of the fastener grommet.

6. The apparatus of claim 1 further comprising:
the insertion axes of the bayonet grommet, the plug-n-play grommet, and the fastener grommet being generally perpendicular with respect to one another.

7. The apparatus of claim 1 further comprising the bayonet grommet located on the windshield wiper drive spaced from the elongate support member.

8. The apparatus of claim 1 further comprising:
the plug-n-play grommet located adjacent to one end of the elongate support member.

9. The apparatus of claim 1 further comprising the fastener grommet located adjacent one end of the elongate support member.

10. The apparatus of claim further comprising:
the plug-n-play grommet and the fastener grommet located adjacent opposite ends of the elongate support member.

11. The apparatus of claim 1 further comprising:
the plug-n-play grommet including a projection and a vibration dampening grommet, the vibration dampening grommet having an aperture for receiving the projection and outwardly extending barbs for engagement with the motor vehicle.

12. The apparatus of claim 1 further comprising:
the bayonet grommet having a vibration dampening complementary: portion of a male-female connector for engagement with the motor vehicle.

13. The apparatus of claim 1 further comprising:
the fastener grommet having a vibration dampening portion with an aperture for receiving a fastener therethrough for attaching to the motor vehicle.

14. In an apparatus for mounting a windshield wiper system to a motor vehicle having an elongate support member connectible to a windshield wiper drive, the improvement comprising the combination of:
at least one plug-n-play grommet, at least one fastener grommet, and at least one bayonet grommet, each grommet connectible to one of the support member and the wiper drive, wherein at least two grommets are connected to the elongate support member, each of the two grommets having an insertion axis, wherein the insertion axis of one of the two grommets extends in a non-parallel relationship with respect to the other insertion axis.

15. The improvement of claim 14 further comprising:
each grommet including a vibration dampening portion to be attached with respect to the motor vehicle.

16. The improvement of claim 14 further comprising:
the insertion axis of the bayonet grommet being located generally perpendicular with respect to the insertion axis of the plug-n-play grommet.

17. The improvement of claim 14 further comprising:
the insertion axis of the bayonet grommet being located generally perpendicular with respect to the insertion axis of the fastener grommet.

18. The improvement of claim 14 further comprising:
the insertion axis of the plug-n-play grommet being located generally perpendicular with respect to the insertion axis of the fastener grommet.

19. The improvement of claim 14 further comprising:
the insertion axes of the bayonet grommet, the plug-n-play grommet, and the fastener grommet being generally perpendicular with respect to one another.

20. The improvement of claim 14 further comprising the bayonet grommet located on the windshield wiper drive spaced from the elongate support member.

21. The improvement of claim 14 further comprising:
the plug-n-play grommet located adjacent to one end of the elongate support member.

22. The improvement of claim 14 further comprising the fastener grommet located adjacent one end of the elongate support member.

23. The improvement of claim 14 further comprising:
the plug-n-play grommet and the fastener grommet located adjacent opposite ends of the elongate support member.

24. The improvement of claim 14 further comprising:
the plug-n-play grommet including a projection and a vibration dampening grommet, the vibration dampening grommet having an aperture for receiving the projection and outwardly extending barbs for engagement with the motor vehicle.

25. The improvement of claim 14 further comprising:
the bayonet grommet having a vibration dampening complementary portion of a male-female connector for engagement with the motor vehicle.

26. The improvement of claim 14 further comprising:
the fastener grommet having a vibration dampening portion with an aperture for receiving a fastener therethrough for attaching to the motor vehicle.
